(19) United States
(12) Patent Application Publication
(10) Pub. No.: US 2026/0135245 A1
(43) Pub. Date: May 14, 2026

(54) POWER STORAGE DEVICE

(71) Applicant: TOYOTA JIDOSHA KABUSHIKI KAISHA, Toyota-shi (JP)

(72) Inventors: Makoto IWATA, Toyota-shi (JP); Shotaro Ishikawa, Miyoshi-shi (JP); Shunsuke Fujiwara, Toyota-shi (JP); Soichiro Nakamura, Toyota-shi (JP); Takahiko Nakano, Toyota-shi (JP); Kosuke Suzuki, Toyota-shi (JP); Masahiro Ishizuka, Toyota-shi (JP); Kensuke Matsuo, Seto-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/308,684

(22) Filed: Aug. 25, 2025

(30) Foreign Application Priority Data
Nov. 13, 2024 (JP) 2024-198010

(51) Int. Cl. H01M 50/358; B60L 50/64; H01M 50/209; H01M 50/249; H01M 50/342

(52) U.S. Cl. CPC H01M 50/358; H01M 50/209; H01M 50/249; H01M 50/3425; B60L 50/64; H01M 2220/20

(57) ABSTRACT

A power storage device includes: a plurality of power storage cells arranged along one direction; a bottom wall disposed below the power storage cells; and a panel member provided below the bottom wall and defining a smoke exhaust path together with the bottom wall. A safety valve is provided in a lower surface of each of the power storage cells. The bottom wall includes a plurality of fragile portions provided at positions facing each safety valve.

### CROSS-REFERENCE TO RELATED APPLICATION

This application claims priority to Japanese Patent Application No. 2024-198010 filed on Nov. 13, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2023-126584 (JP 2023-126584 A), for example, discloses a battery including a plurality of cells, a case that houses the cells, a protective member that protects a bottom portion of the case, and a cover. Each of the cells includes a box that houses an electrode assembly. A relief mechanism is provided in a bottom surface of the box. Exhaust discharged from the relief mechanism flows into a collection cavity formed between the bottom portion of the case and the protective member.

### SUMMARY

In the battery described in JP 2023-126584 A, a heat insulating member made of mica or the like may be disposed at a portion of the bottom portion of the case facing the relief mechanism, in order to protect the underside of the cells from a gas contained in the exhaust from the cells. However, as the number of the cells increases, the cost required for the heat insulating member also increases.

An object of the present disclosure is to provide a power storage device capable of protecting the underside of power storage cells from a gas while suppressing a significant increase in cost.

An aspect of the present disclosure provides a power storage device including: a plurality of power storage cells arranged along one direction; a bottom wall disposed below the power storage cells; and a panel member provided below the bottom wall and defining a smoke exhaust path together with the bottom wall, in which: a safety valve is provided in a lower surface of each of the power storage cells; and the bottom wall includes a plurality of fragile portions each provided at a position facing the safety valve.

According to the present disclosure, there is provided a power storage device capable of protecting the underside of power storage cells from a gas while suppressing a significant increase in cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a power storage device according to an embodiment of the present disclosure;

FIG. 2 is a plan view schematically illustrating a state in which an upper cover has been removed from the power storage device;

FIG. 3 is a cross-sectional view taken along the line III-III in FIG. 2;

FIG. 4 is a plan view of a fragile portion;

FIG. 5 is a cross-sectional view schematically illustrating a modification of a bottom wall and fragile portions; and

FIG. 6 is a cross-sectional view schematically illustrating a modification of a bottom wall and fragile portions.

### DETAILED DESCRIPTION OF EMBODIMENTS

An embodiment of the present disclosure will be described with reference to the drawings. In the drawings referred to below, the same or corresponding members are given the same numerals.

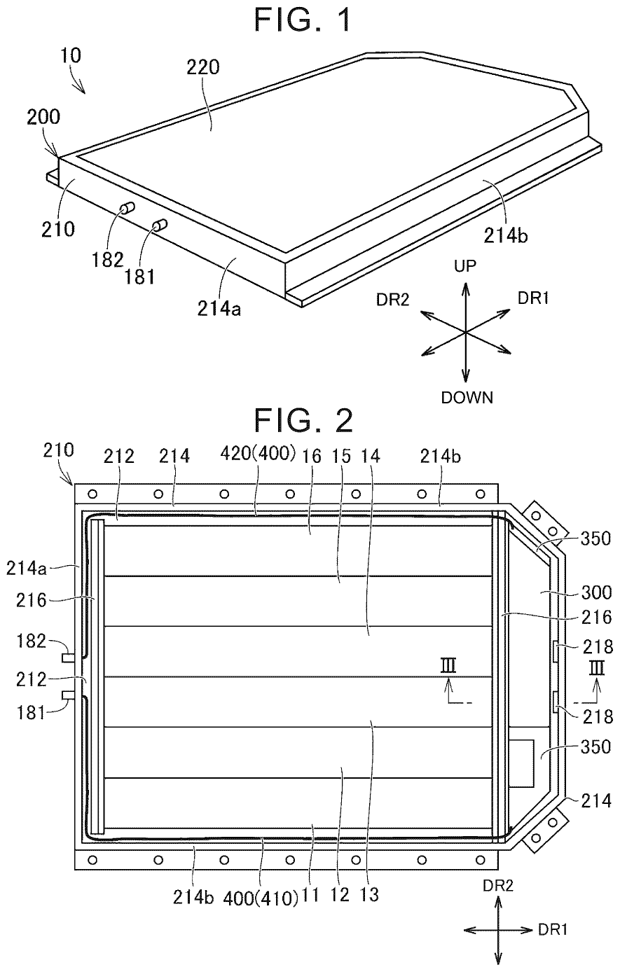

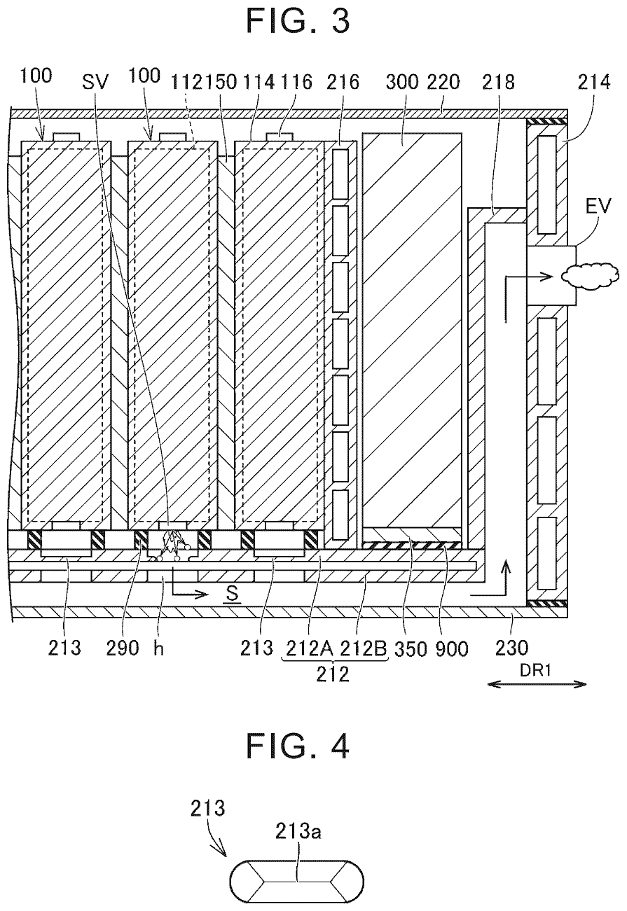

FIG. 1 is a perspective view schematically illustrating a power storage device according to an embodiment of the present disclosure. FIG. 2 is a plan view schematically illustrating a state in which an upper cover has been removed from the power storage device. FIG. 3 is a cross-sectional view taken along the line III-III in FIG. 2.

A power storage device 10 according to the present embodiment is mounted in, for example, a lower part of a vehicle. The vehicle is, for example, a hybrid electric vehicle, a plug-in hybrid electric vehicle, or a battery electric vehicle.

As illustrated in FIGS. 1 to 3, the power storage device 10 includes six power storage stacks 11 to 16, a housing 200, a surrounding member 290, devices 300, a device cooler 350, and refrigerant piping 400. The number of the power storage stacks is not limited to six.

Each of the power storage stacks 11 to 16 is formed in the shape of a rectangular parallelepiped that is elongated in a first direction DR1. As illustrated in FIG. 2, the six power storage stacks 11 to 16 are disposed side by side along a second direction DR2 that is orthogonal to both the first direction DR1 and the up-down direction. In the present embodiment, the first direction DR1 corresponds to the front-rear direction of the vehicle, and the second direction DR2 corresponds to the right-left direction (width direction) of the vehicle. Each of the power storage stacks 11 to 16 includes at least one power storage cell 100. In the present embodiment, each of the power storage stacks 11 to 16 includes a plurality of power storage cells 100 and a plurality of cooling plates 150.

The power storage cells 100 are disposed side by side along the first direction DR1. As illustrated in FIG. 3, each of the power storage cells 100 includes an electrode body 112, a cell case 114, and a pair of external terminals 116.

The electrode body 112 may be composed of a wound body in which a positive electrode sheet and a negative electrode sheet are wound via a separator, or may be composed of a stacked body in which a positive electrode sheet and a negative electrode sheet are stacked via a separator. The electrode body 112 is shaped to be elongated in the second direction DR2.

The cell case 114 houses the electrode body 112. The cell case 114 is formed in a rectangular parallelepiped shape. The cell case 114 is made of a metal such as aluminum. A safety valve SV is provided in a lower surface of the cell case 114.

The external terminals 116 are provided on an upper surface of the cell case 114. The external terminals 116 are provided at positions spaced apart from each other in the width direction of the cell case 114. The width direction of the cell case 114 corresponds to the second direction DR2.

As illustrated in FIG. 3, each of the cooling plates 150 is disposed between a pair of power storage cells 100 adjacent to each other in the first direction DR1. Each of the cooling plates 150 is formed in the shape of a flat plate that is elongated in the second direction DR2. Each of the cooling plates 150 has a flow path (not illustrated) through which a refrigerant flows along the second direction DR2.

The housing 200 houses the six power storage stacks 11 to 16. As illustrated in FIGS. 1 to 3, the housing 200 includes a lower case 210, an upper cover 220, and a panel member 230.

The lower case 210 is open upward. The lower case 210 may be made of a metal such as aluminum. The lower case 210 includes a bottom wall 212, a peripheral wall 214, and a pair of partition walls 216.

The bottom wall 212 is located below the power storage stacks 11 to 16. As illustrated in FIG. 3, the bottom wall 212 is formed to be hollow. The bottom wall 212 may be formed by extrusion. The bottom wall 212 includes an upper plate portion 212A and a lower plate portion 212B.

The upper plate portion 212A is provided below the power storage stacks 11 to 16. The upper plate portion 212A may be formed in a flat plate shape. The upper plate portion 212A has a plurality of fragile portions 213 provided at positions facing each safety valve SV. That is, the number of the fragile portions 213 arranged along the first direction DR1 is the same as the number of the power storage cells 100 included in each of the power storage stacks 11 to 16.

The strength or rigidity of each of the fragile portions 213 is less than the strength or rigidity of the upper plate portion 212A. In the present embodiment, the thickness (dimension in the up-down direction) of each of the fragile portions 213 is set to be less than the thickness of the upper plate portion 212A. As illustrated in FIG. 3, the fragile portions 213 may be provided in a lower part of the upper plate portion 212A. In this example, the upper surface of the fragile portions 213 is located below the upper surface of the upper plate portion 212A, and the lower surface of the fragile portions 213 is formed to be flush with the lower surface of the upper plate portion 212A.

FIG. 4 is a plan view of the fragile portion 213. As illustrated in FIG. 4, the fragile portion 213 includes a thin portion 213a. The thin portion 213a has a thickness that is less than the thickness of a portion of the fragile portion 213 other than the thin portion 213a. When a load acts on the fragile portion 213 from above, the fragile portion 213 ruptures, starting from the thin portion 213a.

The lower plate portion 212B is provided below the upper plate portion 212A. The lower plate portion 212B may be formed in a flat plate shape. The lower plate portion 212B has a plurality of through holes h provided at positions facing the fragile portions 213. The length of the through hole h in the first direction DR1 may be set to be equal to or slightly greater than the length of the fragile portion 213 in the first direction DR1. The length of the through hole h in the second direction DR2 may be set to be equal to or slightly greater than the length of the fragile portion 213 in the second direction DR2.

The surrounding member 290 is provided between the lower surface of the power storage cells 100 and the upper surface of the bottom wall 212. The surrounding member 290 is shaped to surround the fragile portions 213. The surrounding member 290 is made of a resin, a metal, or the like. The surrounding member 290 may be in contact with the lower surface of the cooling plates 150.

The peripheral wall 214 stands up from the peripheral edge portion of the bottom wall 212. The peripheral wall 214 is shaped to surround the power storage stacks 11 to 16. The peripheral wall 214 may be formed to be hollow. The peripheral wall 214 includes a front wall 214a and a pair of side walls 214b.

The front wall 214a is formed on one side (the left side in FIG. 2) of the power storage stacks 11 to 16 in the first direction DR1. The front wall 214a extends in the second direction DR2. In the present embodiment, the one side in the first direction DR1 corresponds to the front side in the front-rear direction of the vehicle.

The side walls 214b face each other at a distance from each other in the second direction DR2. The side walls 214b extend in the first direction DR1. An end portion (front end portion) of each of the side walls 214b on the one side in the first direction DR1 is connected to the front wall 214a.

The partition walls 216 partition a space surrounded by the bottom wall 212 and the peripheral wall 214 into a space in which the power storage stacks 11 to 16 are disposed and the other space. The partition walls 216 are disposed as spaced apart from each other in the first direction DR1. The partition walls 216 extend in the second direction DR2. The partition walls 216 may be formed to be hollow. The partition walls 216 have a function of restraining the power storage stacks 11 to 16 from both sides in the first direction DR1. As illustrated in FIG. 2, end portions, in the second direction DR2, of the partition wall 216 formed on the one side (front side) in the first direction DR1 are spaced apart from the respective side walls 214b. End portions, in the second direction DR2, of the partition wall 216 formed on the other side (rear side) in the first direction DR1 are connected to the respective side walls 214b.

The upper cover 220 is disposed above the power storage stacks 11 to 16. The upper cover 220, together with the lower case 210, houses the six power storage stacks 11 to 16. Specifically, the upper cover 220, together with the lower case 210, houses the six power storage stacks 11 to 16 in a sealed state. The peripheral edge portion of the upper cover 220 is connected to the upper end portion of the peripheral wall 214 by bolts or the like via a seal member.

The panel member 230 is provided below the lower case 210. The panel member 230 has a function of protecting the bottom wall 212 of the lower case 210. The panel member 230 may be formed in a flat plate shape. The peripheral edge portion of the panel member 230 is connected to the lower surface of the lower case 210 via a seal member.

As illustrated in FIG. 3, a space S is formed between the panel member 230 and the bottom wall 212. The space S functions as a smoke exhaust path (hereinafter referred to as a “smoke exhaust path S”). The smoke exhaust path S is a path for discharging a gas discharged from the safety valve SV of the power storage cell 100 to the outside of the housing 200.

As illustrated in FIGS. 2 and 3, a smoke exhaust duct portion 218 is formed on the peripheral wall 214. The smoke exhaust duct portion 218 extends upward from the bottom wall 212. The smoke exhaust duct portion 218 guides a gas upward from the smoke exhaust path S. An explosion-proof valve EV is provided at the downstream end portion of the smoke exhaust duct portion 218. The explosion-proof valve EV releases the pressure within the housing 200. The explosion-proof valve EV opens when the pressure within the housing 200 becomes equal to or greater than a reference value. The explosion-proof valve EV is composed of a check valve. As illustrated in FIG. 3, when a gas is discharged from any of the power storage cells 100, the gas spreads in the first direction DR1 through the smoke exhaust path S and is discharged to the outside of the housing 200 through the smoke exhaust duct portion 218 and the explosion-proof valve EV.

The devices 300 are housed in the housing 200. As illustrated in FIG. 2, the devices 300 are disposed on the other side of the lower case 210 in the first direction DR1, that is, in a space formed between the partition wall 216 formed on the other side (rear side) in the first direction DR1 and the peripheral wall 214. The devices 300 may include a junction box. The devices 300 may include a relay, a control device, and the like.

The device cooler 350 cools the devices 300. As illustrated in FIGS. 2 and 3, the device cooler 350 is provided between the bottom wall 212 and the devices 300. A thermally conductive adhesive 900 may be provided between the device cooler 350 and the bottom wall 212.

The refrigerant piping 400 is routed inside the housing 200. The refrigerant piping 400 is connected to the cooling plates 150 and the device cooler 350. As illustrated in FIGS. 1 and 2, the front wall 214a of the peripheral wall 214 is provided with an inlet port 181 and an outlet port 182. The refrigerant piping 400 is connected to the inlet port 181 and the outlet port 182. Therefore, the refrigerant (such as water or oil) supplied from the inlet port 181 flows into the cooling plates 150 and the device cooler 350 through the refrigerant piping 400, cools the power storage cells 100 and the devices 300, and then flows out from the outlet port 182 through the refrigerant piping 400.

As illustrated in FIG. 2, the refrigerant piping 400 includes upstream piping 410 and downstream piping 420.

The upstream end portion of the upstream piping 410 is connected to the inlet port 181. The downstream end portion of the upstream piping 410 is connected to one end portion of the device cooler 350 in the second direction DR2. The upstream piping 410 is routed to pass between the front wall 214a and the partition wall 216 formed on the one side in the first direction DR1, and between the power storage stack 11 disposed on one side in the second direction DR2 and the side wall 214b. The upstream piping 410 is connected to one end portion of each of the cooling plates 150 in the second direction DR2.

The upstream end portion of the downstream piping 420 is connected to the other end portion of the device cooler 350 in the second direction DR2. The downstream end portion of the downstream piping 420 is connected to the outlet port 182. The downstream piping 420 is routed to pass between the front wall 214a and the partition wall 216 formed on the one side in the first direction DR1, and between the power storage stack 16 disposed on the other side in the second direction DR2 and the side wall 214b. The downstream piping 420 is connected to the other end portion of each of the cooling plates 150 in the second direction DR2.

In the power storage device 10 described above, when exhaust is discharged downward from the safety valve SV because of a short circuit or the like in any of the power storage cells 100, the exhaust collides against the fragile portion 213. Then, the fragile portion 213 ruptures, starting from the thin portion 213a, and therefore the exhaust containing the content (so-called debris) of the power storage cell 100 flows into the smoke exhaust path S through the through hole h. Thereafter, the gas contained in the exhaust spreads in the smoke exhaust path S and is discharged from the housing 200 through the explosion-proof valve EV as illustrated in FIG. 3. Thus, the adhesion of the content of the power storage cell 100 to the external terminals 116 and the like is suppressed.

Modifications of the above embodiment will be described below.

### FIRST MODIFICATION

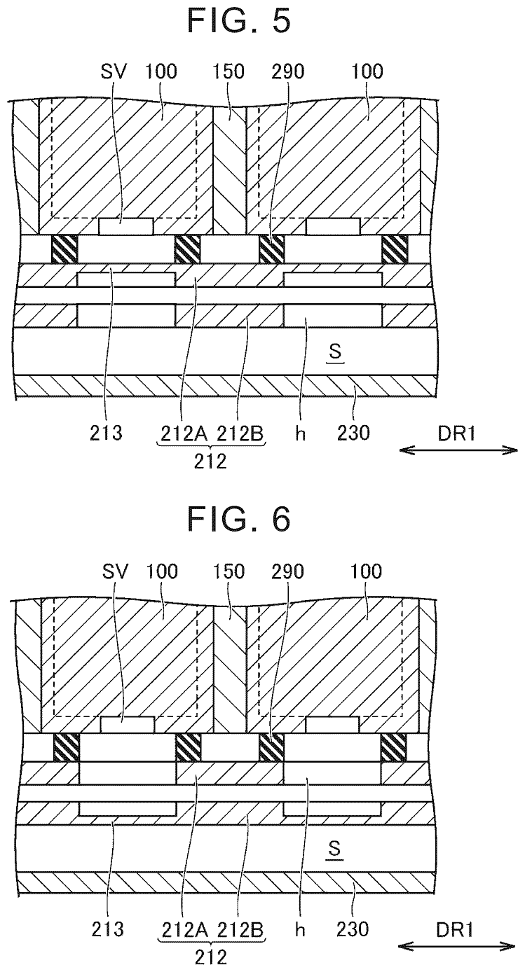

As illustrated in FIG. 5, the fragile portions 213 may be provided in an upper part of the upper plate portion 212A. In this example, the upper surface of the fragile portions 213 is formed to be flush with the upper surface of the upper plate portion 212A, and the lower surface of the fragile portions 213 is located above the lower surface of the upper plate portion 212A.

### SECOND MODIFICATION

As illustrated in FIG. 6, the fragile portions 213 may be provided in the lower plate portion 212B. In this example, the upper surface of the fragile portions 213 is located below the upper surface of the lower plate portion 212B, and the lower surface of the fragile portions 213 is formed to be flush with the lower surface of the lower plate portion 212B. Furthermore, through holes h are formed in the upper plate portion 212A.

Although not illustrated in the drawings, when the fragile portions 213 are provided in the lower plate portion 212B, the upper surface of the fragile portions 213 may be formed to be flush with the upper surface of the lower plate portion 212B, and the lower surface of the fragile portions 213 may be located above the lower surface of the lower plate portion 212B.

It will be understood by a person skilled in the art that the exemplary embodiment described above is a specific example of the following aspects.

### FIRST ASPECT

A power storage device including:
a plurality of power storage cells arranged along one direction;
a bottom wall disposed below the power storage cells; and
a panel member provided below the bottom wall and defining a smoke exhaust path together with the bottom wall, in which:
a safety valve is provided in a lower surface of each of the power storage cells; and
the bottom wall includes a plurality of fragile portions each provided at a position facing the safety valve.

In this power storage device, the fragile portions rupture when struck by exhaust containing a content (so-called debris) of the power storage cell, but do not rupture with a gas contained in the exhaust. Therefore, it is possible to protect the lower surface of the power storage cells from the gas while suppressing an increase in cost by omitting a heat insulating member for protecting the power storage cells from the gas.

### SECOND ASPECT

The power storage device according to the first aspect, in which:
the bottom wall includes
   an upper plate portion provided below the power storage cells, and
   a lower plate portion provided below the upper plate portion; and
each of the fragile portions is provided in the upper plate portion.

In this aspect, the distance between the fragile portions and the safety valves is less than when the fragile portions are provided in the lower plate portion, and therefore the time required for the fragile portions to rupture is reduced.

### THIRD ASPECT

The power storage device according to the second aspect, in which a thickness of the fragile portions is less than a thickness of the upper plate portion.

### FOURTH ASPECT

The power storage device according to the third aspect, in which:
an upper surface of the fragile portions is located below an upper surface of the upper plate portion; and
a lower surface of the fragile portions is flush with a lower surface of the upper plate portion.

### FIFTH ASPECT

The power storage device according to any one of the second to fourth aspects, further including a surrounding member provided between each of the power storage cells and the upper plate portion and surrounding the fragile portions.

In this aspect, the exhaust discharged from the safety valve effectively collides against the fragile portion.

The embodiment disclosed herein should be considered to be exemplary in all respects and not restrictive. The scope of the present disclosure is defined by the claims rather than the above description of the embodiment, and further includes all modifications that fall within the meaning and scope equivalent to the claims.

What is claimed is:

1. A power storage device comprising:
a plurality of power storage cells arranged along one direction;
a bottom wall disposed below the power storage cells; and
a panel member provided below the bottom wall and defining a smoke exhaust path together with the bottom wall, wherein:
a safety valve is provided in a lower surface of each of the power storage cells; and
the bottom wall includes a plurality of fragile portions each provided at a position facing the safety valve.

2. The power storage device according to claim 1, wherein:
the bottom wall includes
an upper plate portion provided below the power storage cells, and
a lower plate portion provided below the upper plate portion; and
each of the fragile portions is provided in the upper plate portion.

3. The power storage device according to claim 2, wherein a thickness of the fragile portions is less than a thickness of the upper plate portion.

4. The power storage device according to claim 3, wherein:
an upper surface of the fragile portions is located below an upper surface of the upper plate portion; and
a lower surface of the fragile portions is flush with a lower surface of the upper plate portion.

5. The power storage device according to claim 2, further comprising a surrounding member provided between each of the power storage cells and the upper plate portion and surrounding the fragile portions.
